(19) United States
(12) Patent Application Publication
(10) Pub. No.: US 2014/0067457 A1
(43) Pub. Date: Mar. 6, 2014

(54) WORKFLOW EXECUTION FRAMEWORK

(71) Applicants: ABHISHEK NAGENDRA, Bangalore (IN); Arindam Bhattacharjee, Bangalore (IN); Girish Kalasa Ganesh Pai, Bangalore (IN)

(72) Inventors: ABHISHEK NAGENDRA, Bangalore (IN); Arindam Bhattacharjee, Bangalore (IN); Girish Kalasa Ganesh Pai, Bangalore (IN)

(21) Appl. No.: 13/596,355

(22) Filed: Aug. 28, 2012

(51) Int. Cl. G06Q 10/06

(52) U.S. Cl. 705/7.27

(57) ABSTRACT

A workflow execution framework is generated to execute a received workflow. The workflow is semantically analyzed to determine workflow chain and associated workflow components. To execute the workflow chain, a terminal component in the workflow chain and a corresponding sequential hierarchy of the workflow components are detected. A result descriptor of a data source component corresponding to the terminal component is computed and stored in an execution state table. Result descriptors are computed for the workflow components succeeding the data source component in the sequential hierarchy and are stored in the execution state table. Upon detecting a dataflow between the data source component and one of the succeeding workflow components, data along each row of the execution state table is extracted to process the one of the succeeding workflow components. The workflow is executed by processing the workflow components associated with the workflow chain, thereby executing the workflow chain.

### TECHNICAL FIELD

The field generally relates to computer systems and software and more particularly to methods and systems to generate a workflow execution framework.

### BACKGROUND

A data mining process generally extracts associated business information from corresponding data sources and organizes the business information. A dataflow in a business process is typically executed in a pipeline architecture, where one dataflow element is connected to another via one or more pipes. Each element in the pipeline completes its processing and an output of the processing is passed on to a succeeding element(s) via a pipe(s). Since each element needs to store complete information for processing, enormous data has to be accessed for data mining process. Also, passing an output of one element as an input to multiple elements may create a lag in data mining, since the latter elements wait for the execution of a former element.

### BRIEF DESCRIPTION OF THE DRAWINGS

The claims set forth the embodiments with particularity. The embodiments are illustrated by way of example and not by way of limitation in the figures of the accompanying drawings in which like references indicate similar elements. The embodiments, together with its advantages, may be best understood from the following detailed description taken in conjunction with the accompanying drawings.

FIG. 1A is a block diagram illustrating an overview of a system to generate a workflow execution framework, according to an embodiment.

FIGS. 1B and 1C are block diagrams of exemplary workflows to be executed in a workflow execution framework, according to an embodiment.

FIG. 2 is a sequence diagram illustrating a data flow to generate a workflow execution framework, according to an embodiment.

FIG. 3 is a process flow diagram illustrating a method to generate a workflow execution framework, according to an embodiment.

FIG. 4 is a process flow diagram illustrating a method to generate a workflow execution framework, according to an embodiment.

FIG. 5 is a block diagram illustrating an exemplary computer system, according to an embodiment.

### DETAILED DESCRIPTION

Embodiments to generate a workflow execution framework are disclosed herein. A workflow execution framework may represent a reusable set of business rules to execute a received workflow. Elements of the workflow are comparable to filters present at intermediate levels of a water pipe, before water reaches a water tank. The business element behaves as a filter, where the input to the element may be transformed (processed) before it moves to a succeeding element. Maintaining the transformations and processing of information at every stage of the data flow is beneficial for reusing the output of transformation and/or the transformations themselves to process similar elements. For instance, if a part of a workflow is shared between sub-workflow A and sub-workflow B, the output from processing sub-workflow A can be reused to process sub-workflow B. The workflow is associated with a workflow specification, which would give a comprehensive insight of the workflow upon analysis.

The workflows are realized by means of workflow chains, workflow components and a workflow repository. The workflow chains depict an execution flow or a linkage of the business information; they include workflow components that are interconnected, to represent the execution flow. The workflow chains aid the flow of information between the workflow components, in the workflow. The workflow chains are capable of establishing a link between the workflow components, to define an order of the execution. The workflow components are processing units associated with predictive analysis services and systems. These services comprehend a variety of statistical techniques to analyze current and historical business information and make prognostic decisions. The components, based upon their expertise, are categorized as data source components, algorithmic components, pre-processing components, data writer components, terminal components, and the like. The workflow chain may be executed by utilizing a data-pull mechanism, where the data is extracted from a preceding component to execute a succeeding component. The workflow chains may be executed using a bottom-up approach, by beginning the processing from a terminal component, and extracting the data (for example, output) from a preceding component. The bottom-up approach of execution facilitates an execution of multiple workflow chains in parallel. The outputs of the workflow components are stored in a centralized workflow repository, and can be reused accordingly.

In an embodiment, the workflow components in the workflow chain are arranged in a sequential hierarchy. A sequential hierarchical arrangement represents a series of interdependent components, orchestrated by connecting the components to represent the execution flow. In a sequential hierarchy, the workflow components are capable of using an output or a result of a preceding workflow component to execute a succeeding workflow component. A sequential hierarchy of a terminal component XYZ includes a data source component (a first component), one or more intermediate components, and the terminal component XYZ in an order depicting the execution flow and/or the dataflow. In an embodiment, the workflow chain may be represented as a parent-child structure, where a data source component is a parent component, and a component succeeding the parent component is a child component. A parent component is one that does not have a preceding component. A parent component does not extract data (result/output) from a preceding component for execution. A child component is one that utilizes result or output from a preceding component for execution. A terminal component is one that has succeeding components.

A workflow chain may include simple chain executions and complex chain executions. A simple workflow chain has a sequential set of workflow components in a single branch of the workflow chain. For instance, a workflow chain having a single data source and a single terminal component with corresponding sequential intermediate components constitute a simple workflow chain. A complex workflow chain has a sequential set of workflow components in multiple branches, and each branch shares a workflow component with another branch. For instance, a workflow chain having a single data source, and two terminal components with corresponding sequential intermediate components constitute a complex workflow chain.

Execution of the workflow chain may be made up of two phases, namely, a component execution phase and a chain processing phase. The component execution phase describes a stage in the workflow, where the workflow components are executed. The workflow components may be executed by utilizing the output of a preceding component, and upon execution of each component, the output result may be stored in the centralized workflow repository. The chain processing phase describes a stage in the workflow, where the workflow chain is executed by processing the workflow linkage between the components and the chain, thereby executing the workflow.

In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

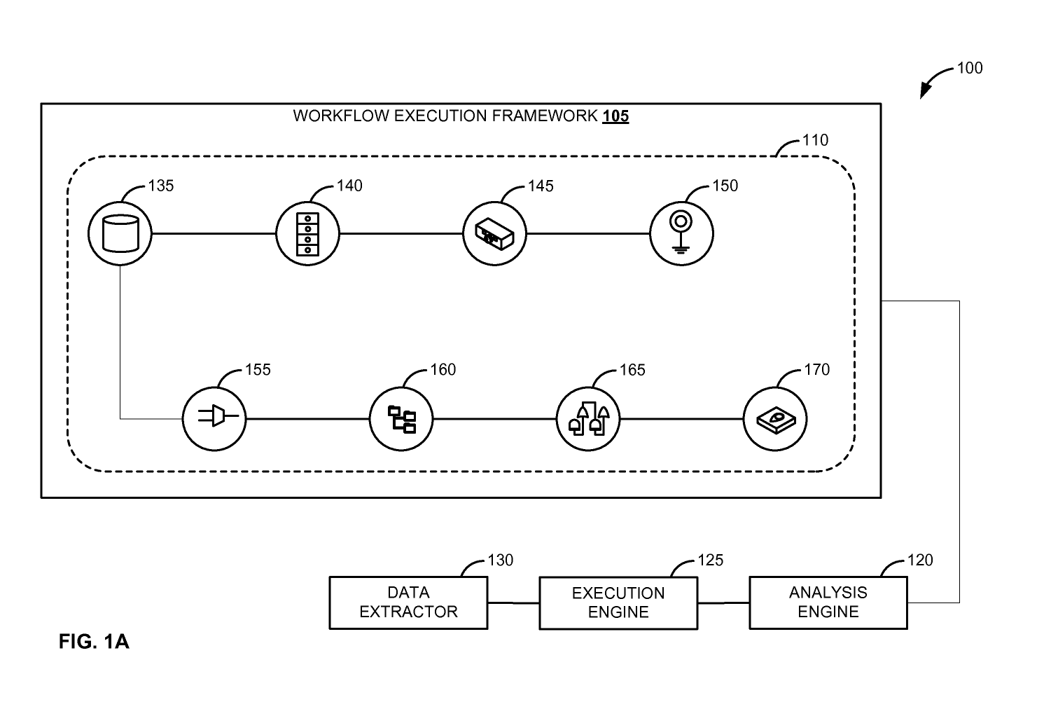

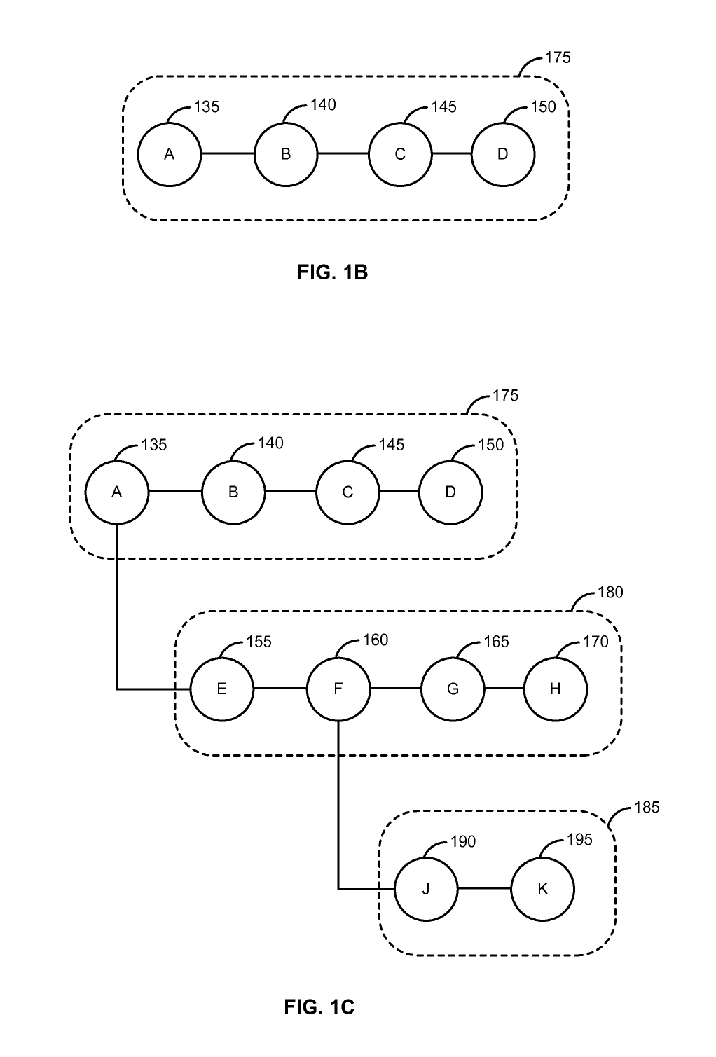

FIG. 1A is a block diagram illustrating an overview of a system to generate a workflow execution framework, according to an embodiment. System 100 represents a system to generate a workflow execution framework. System 100 includes workflow execution framework 105, received workflow 110 with workflow components 135, 140, 145, 150, 155, 160, 165 and 170; data extractor 130, execution engine 125, and analysis engine 120. In an embodiment, the workflow is received at a predictive analysis engine from an external source, a user, or as a resultant of an associated process. The received workflow may include semantics associated with contents of the workflow, like a number of workflow chains, workflow sub-chains, interconnectivities of sub-chains, interdependencies of workflow chains and/or components, and the like. The received workflow 110 is semantically analyzed by analysis engine 120 to determine a workflow chain and associated series of workflow components 135, 140, 145, 150, 155, 160, 165 and 170. Performing semantic analysis includes realizing the received workflow to determine a number of workflow sub-chains, determine interconnectivities of the sub-chains, determine workflow components associated with each chain, and the like. FIG. 1B represents a simple workflow chain, and FIG. 1C represents a complex workflow chain. Analysis engine 120 initiates a component execution phase of workflow execution.

Consider a simple workflow chain represented by FIG. 1B. In the component execution phase, terminal component 150 in workflow chain 175 and a sequential hierarchy of the workflow components (135, 140, 145 and 150) corresponding to terminal component 150 are detected by a processor associated with execution engine 125. Further, data source component 135 of the sequential hierarchy corresponding to terminal component 150 is detected by the processor, and a result descriptor is computed for data source component 135. A result descriptor represents a resultant or an output of an execution of the workflow component. For instance, workflow component 135 represents a data source component, which stores business information associated with the workflow. In an embodiment, executing workflow component 135 includes querying the business information in data source component 135 to retrieve metadata of the workflow. The result descriptor computed for the execution of component 135 includes metadata of the workflow. Upon computing the result descriptor for data source component 135 corresponding to terminal component 150, execution engine 125 generates an execution state table to store the result descriptor of data source component 135. The execution state table may be represented as a database table, with a plurality of rows and columns. Each column may represent an attribute of the table, and each row may represent a corresponding element of the result descriptor of component 135. Upon computing data source component 135, the processor computes result descriptors for all (intermediate) workflow components 140 and 145 in workflow chain 175 between data source component 135 and terminal component 150. The result descriptors are computed according to a sequential hierarchy in which the components exist, by utilizing the result descriptor of the preceding component as an input to execute the succeeding component. The execution of workflow components 140 and 145 is carried out in a manner similar to data source component 135, by executing the process represented by components 140 and 145. Upon computing the result descriptors for component 140 and 145, the processor stores the result descriptors in the execution state table. In an embodiment, the execution state table is stored in the centralized workflow repository.

Upon detecting a dataflow between two components, for example between component 135 and component 140, execution engine 125 triggers data extractor 130 to execute the chain processing phase. In chain processing phase, data extractor 130 begins processing workflow chain 175 in a bottom-up manner, by beginning the processing of terminal component 150. Terminal component 150 is processed by extracting data corresponding to preceding component 145, from the execution state table. The data is extracted along each row from a plurality of rows corresponding to component 145. Upon processing a first corresponding row, data extractor 130 fetches a second corresponding row for processing, and so on, until all the rows corresponding to the preceding component 145 are processed. During the processing of component 145, if the result descriptor of the component preceding the component 145 is required, the data corresponding to component 140 (which is the component preceding component 145) is extracted from the execution state table in the same row-wise manner. The result descriptors are stored in a row-wise manner in the execution state table to facilitate row-wise data extraction. Even when the data size of the result descriptors is huge, the workflow chain execution process is not influenced since the extraction occurs one row at a time. This bottom-up process of extracting the result descriptors of all the components (that is, 150, 145, 140 and 135) in workflow chain 175 to process workflow chain 175 is completed to complete the execution of the received workflow. The processing of the components in the chain processing phase is carried out in a reverse sequential hierarchy by initiating the extraction at the execution table row associated with the terminal component.

Consider a complex workflow chain represented by FIG. 1C. This figure includes multiple workflow chains 175, 180 and 185. The complex workflow chain has a sequential set of workflow components 135, 140, 145, 150 of branch 175; components 155, 160, 165 and 170 of branch 180; and components 190, 195 of branch 185. Each branch shares a workflow component with another branch. For instance, branch 175 and 180 have a common component 135; and, branch 180 and 185 have a common component 160. The components within the branch/chain are arranged in a sequential hierarchy similar to the simple chain in FIG. 1B. Hence, an entire workflow represented by 110, includes all three branches and the components that are interdependent. The workflow execution framework 105 may represent a reusable set of business rules to execute the received workflow including workflow chains 175, 180 and 185. Analysis engine 120 semantically analyzes received workflow 110, to determine three workflow chains 175, 180 and 185 and associated series of workflow components. Analysis engine 120 detects a plurality of terminal components 150, 170 and 195 associated with workflow chains 175, 180 and 185. Analysis engine 120 generates a workflow thread corresponding to each terminal component and the workflow components in the workflow chain. The threads representing the three workflow chains may be represented as MMM, NNN and PPP corresponding to chains 175, 180 and 185 respectively. The thread MMM includes components 135, 140, 145, and 150, where 150 is the terminal component. The thread NNN includes components 135, 155, 160, 165 and 170, where 170 is the terminal component. The thread PPP includes components 135, 155, 160, 190 and 195, where 195 is the terminal component. In an embodiment, to execute a complex workflow chain, separate workflow threads corresponding to workflow chains with common workflow components are generated. The succeeding threads are put to a freeze state, and a first thread executed. Further, during the execution, the data from the execution state table is reused to execute common workflow components.

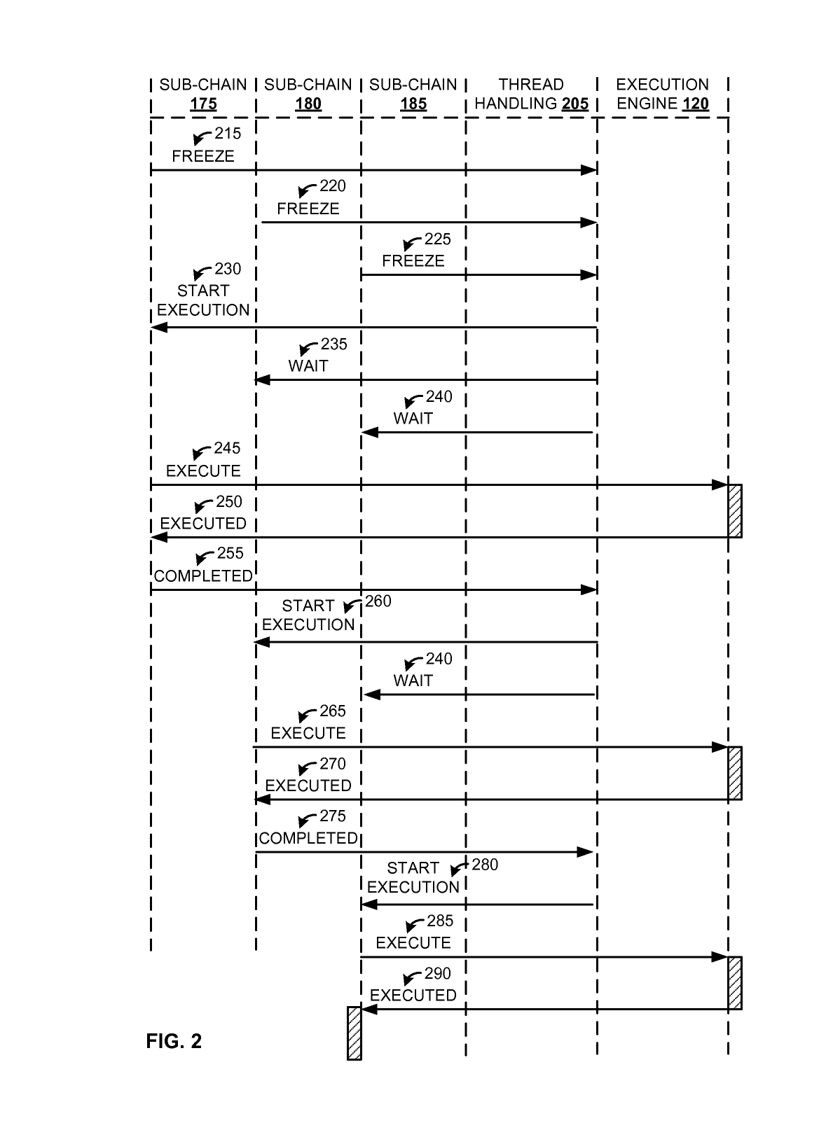

Analysis engine 120 initiates a component execution phase of workflow execution. In component execution phase, the execution occurs with one thread at a given instance. For instance, when thread MMM is being executed, threads NNN and PPP are in a wait state, where the execution of NNN and PPP are paused until MMM is executed. Upon the execution of MMM, a sequentially existing thread, NNN, is released from being paused, and starts the execution. At this instance, PPP continues to be in the wait state. Upon the execution of NNN, PPP is released from being paused, and starts the execution. The instances of execution of the multiple threads are explained with a timing diagram, in FIG. 2.

In the component execution phase, the threads are sequentially executed in a manner similar to the description of FIG. 1B. The first thread, MMM, is executed by computing a result descriptor of data source component 135 corresponding to terminal component 175. The result descriptor of data source component 150 is stored in the execution state table. The result descriptors corresponding to workflow components 135, 140, 145 and 150 are computed, and the result descriptors are stored in the execution state table. The result descriptors are computed according to a sequential hierarchy in which the components exist, by utilizing the result descriptor of the preceding component as an input to execute the succeeding component. Upon execution all the components in thread MMM, thread NNN is released for execution. For thread NNN, component 135 is treaded as data source component. The result descriptor of data source component 135 stored in the execution state table is utilized to execute a succeeding component 155. The rest of the components 160, 165 and 170 are executed in a similar manner by computing result descriptors for each component, and storing the result descriptors in the execution state table. Upon execution all the components in thread NNN, thread PPP is released for execution. For thread PPP, component 135 is treaded as data source component. The result descriptor of data source component 135 stored in the execution state table is utilized to execute a succeeding component 155. The rest of the components 155, 160, 190 and 195 are executed in a similar manner by computing result descriptors for each component, and storing the result descriptors in the execution state table.

Upon detecting a dataflow between two components, execution engine 125 triggers data extractor 130 to execute the chain processing phase. In chain processing phase, data extractor 130 begins processing the workflow 110, by processing the first thread and locking the remaining threads. Accordingly, data extractor 130 executes the first thread MMM, and freezes the execution of threads NNN and PPP. Upon processing the first thread MMM, the second thread NNN is released for processing, and upon processing NNNN, the third thread PPP is released for processing. Processing the threads is similar to processing the simple workflow chain, explained for simple chain execution. Data extractor 130 begins processing workflow chain 175 in a bottom-up manner, by beginning the processing of terminal component 150. Terminal component 150 is processed by extracting data corresponding to preceding component 145, from the execution state table. The data is extracted along each row from a plurality of rows corresponding to component 145. Upon processing a first corresponding row, data extractor 130 fetches a second corresponding row for processing, and so on, until all the rows corresponding to the preceding component 145 are processed. This bottom-up process of extracting the result descriptors of all the components (150, 145, 140 and 135) in workflow chain 175 is completed to begin processing the second thread NNN. During the processing of component 155 in thread NNN, if the result descriptor of the component (135) preceding the component 155 is required, the data corresponding to component 135 is extracted from the execution state table in the same row-wise manner. This bottom-up process of extracting the result descriptors of all the components (170, 165, 160, 155 and 135) in the second thread NNN completed to begin processing the third thread PPP. During the processing of component 190 in thread PPP, if the result descriptor of the component (160) preceding the component 190 is required, the data corresponding to component 160 is extracted from the execution state table in the same row-wise manner. This bottom-up process of extracting the result descriptors of all the components (195, 190, 160, 155 and 135) in the third thread PPP is completed to complete the processing of the workflow 110. Workflow execution framework 105 is generated to execute such simple and complex workflows.

In an embodiment, workflow execution framework 105 is optimized by reusing the result descriptors stored in the execution state table to execute a succeeding workflow component. For instance, to execute component 190, the result descriptor of 160 may be reused from the execution state table. Similarly, if there is a correlation between component 190 and component 155, the result descriptor of component 155 along with result descriptor of 160 may be used to execute component 190. In another embodiment, a procedure to store the result descriptors in the execution state table is optimized by collating the result descriptors and updating the execution state table with the collated result descriptors. For instance, the result descriptors of components 135, 140, 145 and 150 are collated and the execution state table is updated with the collated result descriptors, thereby reducing a number of communications with the execution state table.

Upon executing the workflow, in an embodiment, a unique access identifier is generated to represent each result of execution. An execution completion status is determined for each workflow component in the workflow. The unique access identifier and the status are stored in the execution state table. Upon detecting a workflow chain in a received workflow, which is already executed, the execution state table can be accessed to reuse the result of the execution. The unique access identifier may also be used to re-execute an executed workflow chain. For instance, if a property of a terminal workflow component, 150 is modified, the result descriptors of workflow component 150 are removed from the execution state table. Since 150 is a terminal component; a re-execution of the workflow chain may be initiated. The workflow components succeeding the terminal component 150 need not be re-executed since no modifications have occurred in them. The result descriptors of the preceding components are extracted from the execution state table, and the workflow execution is completed by re-executing component 150 alone. In another example, if a property of component 155 is changed, components that are interdependent on component 155 have to be re-executed along with re-executing component 155. When the chain is re-executed, the modified component 155 and all its children components 160, 190 and 195 are marked as modified. The rows representing result descriptors for components 155, 160, 190 and 195 are deleted, and the chain is re-executed; however the results of the unaffected components are re-used from the execution state table.

In an embodiment, the workflow chain is executed by executing one or more impacted data processes of the workflow chain. An impacted data process of the workflow chain may represent an end point until where a workflow execution is requested. Executing the workflow chain includes execution the data processes that are impacted by the received workflow execution request. For instance, consider a workflow chain includes one hundred workflow components, and twenty terminal components. A workflow execution request received may specify an ‘execute till workflow component number thirty’ option. Upon receiving such an option, the impacted workflow components until the thirtieth workflow component are determined and treated as impacted data processes. The execution of the workflow chain completes upon completing the processing until the thirtieth component.

In an embodiment, multiple workflow threads are identified, and a parallel-processing may be performed for the multiple workflow threads. Parallel-processing involves simultaneously processing components that are not common between the multiple workflow threads. While processing the common components, the multiple threads are processed by freezing succeeding threads and executing one thread at a time.

In another embodiment, an intermediate component may be nominated as a terminal component, to partially execute the workflow chain. The workflow chain is executed until the processing reaches the nominated terminal component. A partial resultant of the partially executed workflow chain is available upon completing the processing of the nominated terminal component.

In an embodiment, while processing multiple workflow threads, if the processor detects an error in a workflow component in a first workflow thread, the execution of the first workflow thread is terminated, and a second workflow thread is released from its ‘freeze state’, and the start processing is initiated for the second workflow thread.

FIG. 2 is a sequence diagram illustrating a data flow to generate a workflow execution framework, according to an embodiment. In an embodiment, a received workflow includes a complex workflow chain having one or more workflow sub-chains. In an embodiment, the workflow sub-chains represent the workflow threads. These workflow sub-chains individually represent a workflow chain, and are executed in a manner identical to the execution of the workflow explained in FIG. 1A. However the execution of a complex workflow chain, which is a combination of a plurality of workflow sub-chains, is represented in the sequence diagram. FIG. 2 represents all the interactions and the operations involved in the method to generate the workflow execution framework. FIG. 2 includes process objects sub-chain 175, sub-chain 180, sub-chain 185, thread handling module 205, and execution engine 120, respectively, along with their respective vertical dotted lines originating from them. The vertical dotted lines of the sub-chain 175, sub-chain 180, sub-chain 185, thread handling module 205, and execution engine 120, represent the processes that may exist simultaneously. The horizontal arrows (for example, 215, 220, 225, 230, 235, 240, 245, 250, 255, 260, 265, 270, 275, 280, 285 and 290) represent the data flow between the vertical dotted lines originating from their respective process objects (for example, 175, 180, 185, 205 and 120). Activation boxes between the horizontal arrows represent the process that is being performed in the respective process object.

Upon receiving a workflow including a complex workflow chain, the complex workflow chain is semantically analyzed to determine a number of workflow sub-chains (e.g. 175, 180 and 185), their interconnectivities, and associated workflow components. The workflow sub-chains 175, 180 and 185 are paused, by setting a ‘freeze’ status. Horizontal arrows represented by 215, 220 and 225 represent the freezing action initiated from the respective sub-chains 175, 180 and 185. By setting a ‘freeze’ status, the workflow sub-chains are locked from being executed. Based upon receiving a trigger to execute the workflow, workflow threads are generated to represent the workflow sub-chains. Execution engine 120 receives the trigger to execute the workflow, and instructs thread handling module 205 to start the execution of the workflow thread representing a first sub-chain, for example, sub-chain 175. Thread handling module 205 instructs sub-chain 175 to start the execution, and the instruction is represented by horizontal arrow 230. Following the instruction to start the execution, thread handling module 205 instructs sub-chains 180 and 185 to pause or freeze from executing. This action of freezing the sub-chains 180 and 185 generates a wait status represented by horizontal arrows 235 and 240 respectively. The first sub-chain 175 executes the workflow thread associated with it, thereby processing the workflow components present in the workflow sub-chain 175. Processing the workflow components in the workflow sub-chain 175 is accomplished in a manner similar to the processing of the workflow components in FIG. 1. To execute workflow sub-chain 175, a terminal component in the workflow sub-chain 175 and a corresponding sequential hierarchy of the workflow components are detected. A result descriptor of a data source component corresponding to the terminal component is computed and stored in an execution state table. Result descriptors are computed for the workflow components succeeding the data source component in the sequential hierarchy and are stored in the execution state table. Upon detecting a dataflow between the data source component and one of the succeeding workflow components, data along each row of the execution state table is extracted to process the one of the succeeding workflow components. Workflow sub-chain 175 is executed by processing the workflow components associated with workflow sub-chain 175. The execution of workflow sub-chain 175 is represented by the activation box at the end of the horizontal arrow 245. Execution engine 120 communicates the execution to sub-chain 175, and the communication is represented by the horizontal arrow 250. Sub-chain 175 communicates the completion of the execution to thread handling module 205, and the communication is represented by the horizontal arrow 255.

Upon completion of the execution of the first thread, thread handling module 205 instructs sub-chain 180 to start execution, and the instruction is represented by horizontal arrow 260. At this instance, the status of sub-chain 180 is released from the freeze status, and the execution of sub-chain 185 remains at the wait status represented by the horizontal arrow 240. The second sub-chain 180 executes the workflow thread associated with it, thereby processing the workflow components present in the workflow sub-chain 180. Workflow sub-chain 180 is executed in a manner similar to the execution of the workflow sub-chain 175. Workflow sub-chain 180 is executed by processing the workflow components associated with workflow sub-chain 180. The execution of workflow sub-chain 180 is represented by the activation box at the end of the horizontal arrow 265. Execution engine 120 communicates the execution to sub-chain 180, and the communication is represented by the horizontal arrow 270. Sub-chain 180 communicates the completion of the execution to thread handling module 205, and the communication is represented by the horizontal arrow 275.

Upon completion of the execution of the second thread, thread handling module 205 instructs sub-chain 185 to start execution, and the instruction is represented by horizontal arrow 280. At this instance, the status of sub-chain 185 is released from the freeze status. The second sub-chain 185 executes the workflow thread associated with it, thereby processing the workflow components present in the workflow sub-chain 185. Workflow sub-chain 185 is executed in a manner similar to the execution of the workflow sub-chain 175. Workflow sub-chain 185 is executed by processing the workflow components associated with workflow sub-chain 185. The execution of workflow sub-chain 185 is represented by the activation box at the end of the horizontal arrow 285. Execution engine 120 communicates the execution to sub-chain 185, and the communication is represented by the horizontal arrow 290. Thus, the complex workflow chain including three workflow sub-chains 175, 180 and 185 are executed.

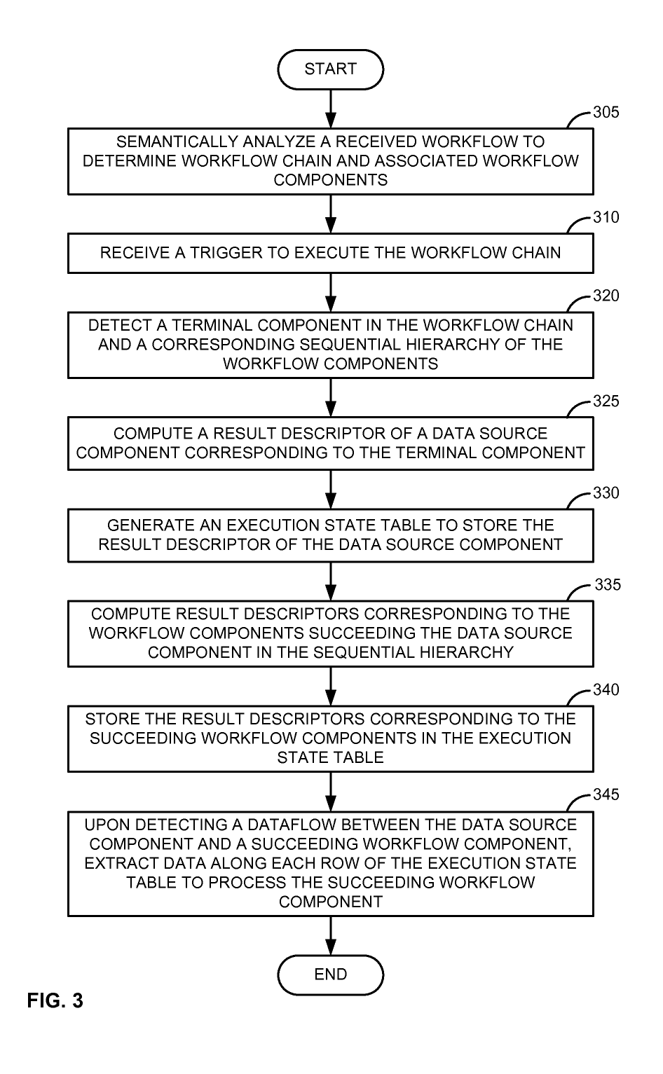

FIG. 3 is a process flow diagram illustrating a method to generate a workflow execution framework, according to an embodiment. In an embodiment, a workflow execution framework is generated to execute a received workflow. In process block 305, the received workflow is semantically analyzed to determine a workflow chain and associated workflow components. In process block 310, a trigger to execute the workflow chain is received. In process block 320, a terminal component in the workflow chain and a corresponding sequential hierarchy of the workflow components is detected. In process block 325, a result descriptor is computed for a data source component corresponding to the terminal component. Computing a result descriptor includes executing a corresponding workflow component (e.g. data source component, terminal component, intermediate workflow component). In process block 330, an execution state table is generated to store the result descriptor of the data source component. In an embodiment, the execution state table includes a plurality of rows, where each row stores an element of the result descriptor. In process block 335, result descriptors are computed for all workflow components succeeding the data source component in the sequential hierarchy. In process block 340, the result descriptors corresponding to the succeeding workflow components are stored in the execution state table. Upon detecting a dataflow between the data source component and a first workflow component succeeding the data source component, data along each row corresponding to the first workflow component is extracted from the execution state table in process block 345, to process the first succeeding workflow component. Upon processing the first workflow component, rest of the workflow components are sequentially processed, until the workflow chain is executed. Further, the workflow is executed and the result of the execution is stored in a centralized repository.

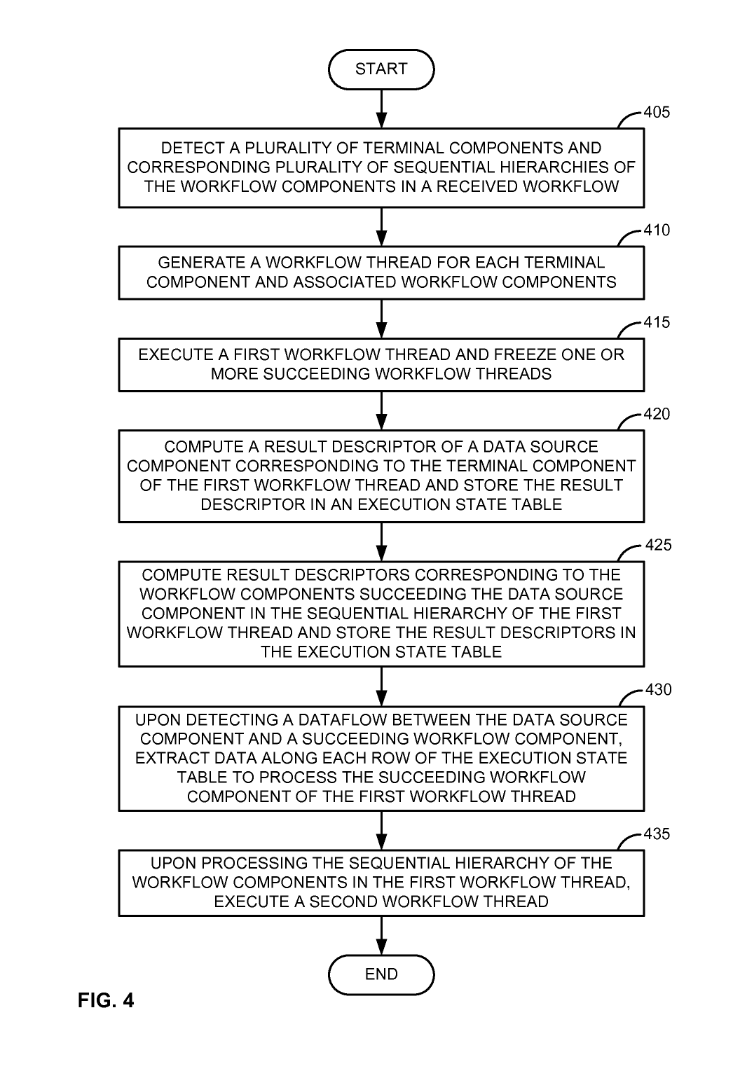

FIG. 4 is a process flow diagram illustrating a method to generate a workflow execution framework, according to an embodiment. In an embodiment, the workflow may include a plurality of terminal components and a corresponding plurality of workflow chains. The workflow is executed by executing the plurality of workflow components and the plurality of workflow chains. In process block 405, a plurality of terminal components are detected in the received workflow. In process block 410, a workflow thread is generated for each terminal component and associated workflow components. Generating a workflow thread includes breaking the workflow chain into one or more workflow threads based upon the terminal component. Thus, a workflow thread includes a terminal component and one or more workflow components in the sequential hierarchy associated with the terminal component. In process block 415, a first workflow thread is executed and the remaining (succeeding) workflow threads are paused, by setting a ‘freeze’ status. By setting a ‘freeze’ status, the remaining workflow threads are locked from being executed, and the lock is released upon a completion of the execution of the first workflow thread. In process block 420, the first workflow thread is executed by computing a result descriptor of a data source component corresponding to the terminal component of the first workflow thread. The result descriptor is stored in the execution state table.

In process block 425, result descriptors are computed for all workflow components succeeding the data source component in the sequential hierarchy of the first workflow thread, and the result descriptors are stored in the execution state table. Upon detecting a dataflow between the data source component and a first workflow component succeeding the data source component in the first workflow thread, data along each row corresponding to the first workflow component is extracted from the execution state table in process block 430, to process the first succeeding workflow component of the first workflow thread. Upon processing the first workflow component, rest of the workflow components in the sequential hierarchy of the first workflow thread are sequentially processed. In process block 435, upon processing the sequential hierarchy of the workflow components in the first workflow thread, a second workflow thread is executed. Further, the plurality of workflow threads is executed to complete the execution of the received workflow; and the result of the execution is stored in a centralized repository.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

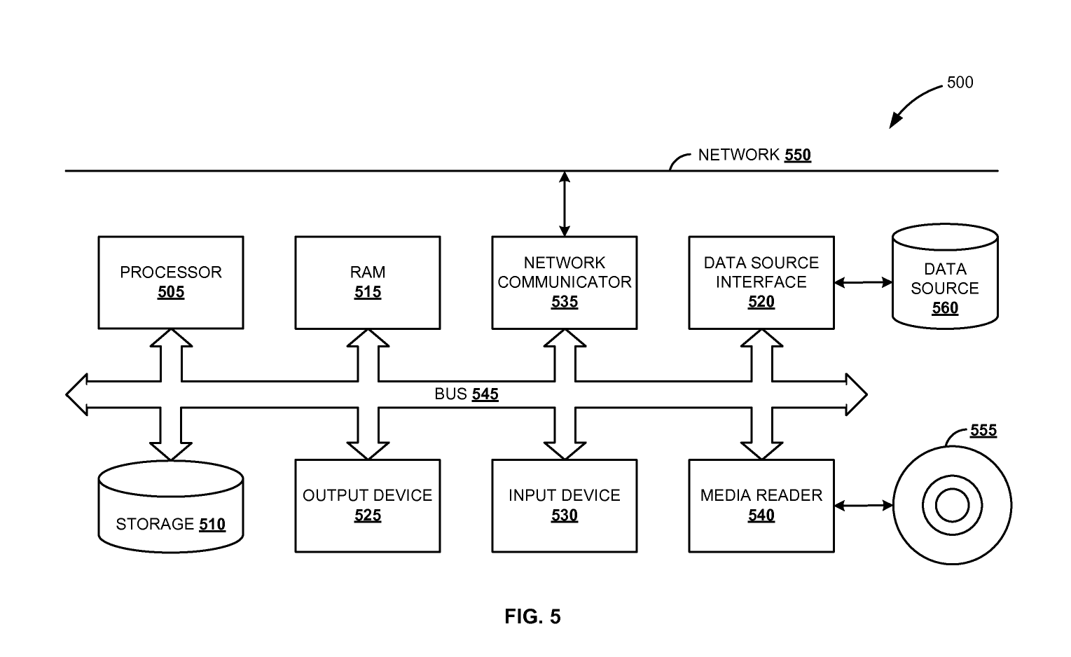

FIG. 5 is a block diagram of an exemplary computer system 500. The computer system 500 includes a processor 505 that executes software instructions or code stored on a computer readable storage medium 555 to perform the above-illustrated methods. The processor 905 can include a plurality of cores. The computer system 500 includes a media reader 540 to read the instructions from the computer readable storage medium 555 and store the instructions in storage 510 or in random access memory (RAM) 515. The storage 510 provides a large space for keeping static data where at least some instructions could be stored for later execution. According to some embodiments, such as some in-memory computing system embodiments, the RAM 515 can have sufficient storage capacity to store much of the data required for processing in the RAM 515 instead of in the storage 510. In some embodiments, all of the data required for processing may be stored in the RAM 515. The stored instructions may be further compiled to generate other representations of the instructions and dynamically stored in the RAM 515. The processor 505 reads instructions from the RAM 515 and performs actions as instructed. According to one embodiment, the computer system 500 further includes an output device 525 (e.g., a display) to provide at least some of the results of the execution as output including, but not limited to, visual information to users and an input device 530 to provide a user or another device with means for entering data and/or otherwise interact with the computer system 500. Each of these output devices 525 and input devices 530 could be joined by one or more additional peripherals to further expand the capabilities of the computer system 500. A network communicator 535 may be provided to connect the computer system 500 to a network 550 and in turn to other devices connected to the network 550 including other clients, servers, data stores, and interfaces, for instance. The modules of the computer system 500 are interconnected via a bus 545. Computer system 500 includes a data source interface 520 to access data source 560. The data source 560 can be accessed via one or more abstraction layers implemented in hardware or software. For example, the data source 560 may be accessed by network 550. In some embodiments the data source 560 may be accessed via an abstraction layer, such as, a semantic layer.

A data source is an information resource. Data sources include sources of data that enable data storage and retrieval. Data sources may include databases, such as, relational, transaction, hierarchical, multi-dimensional (e.g., OLAP), object oriented databases, and the like. Further data sources include tabular data (e.g., spreadsheets, delimited text files), data tagged with a markup language (e.g., XML data), transaction data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer implemented method to generate a workflow execution framework, comprising:
semantically analyzing a received workflow to determine a workflow chain and associated one or more workflow components;
in response to a trigger to execute the workflow chain, detecting a terminal component in the workflow chain and a corresponding sequential hierarchy of the workflow components;
a processor of the computer, computing a result descriptor of a data source component corresponding to the terminal component and generating an execution state table to store the result descriptor of the data source component;
the processor, computing one or more result descriptors corresponding to the workflow components succeeding the data source component in the sequential hierarchy and storing the result descriptors corresponding to the succeeding workflow components in the execution state table; and
upon detecting a dataflow between the data source component and one of the succeeding workflow components, extracting data along each row from one or more corresponding rows of the execution state table to process the one of the succeeding workflow components.

2. The computer implemented method of claim 1 further comprising: receiving the workflow including one or more workflow chains, wherein each workflow chain includes a series of the workflow components interlinked to each other.

3. The computer implemented method of claim 1 further comprising:
processing the one or more workflow components in the workflow chain to complete the execution of the workflow; and
storing the result of the execution of the workflow in a centralized repository.

4. The computer implemented method of claim 1 further comprising:
in response to the trigger to execute the workflow, detecting one or more terminal components associated with one or more workflow chains and corresponding one or more sequential hierarchies of the workflow components;
generating a workflow thread corresponding to each terminal component and associated workflow components corresponding to each workflow chain;
executing a first workflow thread by
computing a result descriptor of a data source component corresponding to the terminal component of the first workflow thread and storing the corresponding result descriptor in the execution state table;
computing the result descriptors corresponding to the workflow components succeeding the data source component in the sequential hierarchy of the first workflow thread and storing the result descriptors corresponding to the succeeding workflow components in the execution state table; and
upon detecting a dataflow between the data source component and one of the succeeding workflow components, extracting data along each row from one or more corresponding rows of the execution state table to process the one of the succeeding workflow components in the first workflow thread; and
upon processing the sequential hierarchy of the workflow components in the first thread, executing a second workflow thread.

5. The computer implemented method of claim 4 further comprising: optimizing the workflow execution framework by reusing one or more result descriptors stored in the execution state table to execute a succeeding workflow component.

6. The computer implemented method of claim 4, wherein executing the first workflow thread includes:
freezing an execution of the second workflow thread during the processing of the sequential hierarchy of the workflow components in the first thread; and
upon processing the first thread, releasing the execution of the second workflow thread to process a sequential hierarchy of the workflow components in the second thread.

7. The computer implemented method of claim 1, wherein extracting the data along each row comprises sequentially extracting row-wise data from the execution state table, upon receiving a request from the terminal component.

8. The computer implemented method of claim 1, wherein extracting the data includes: extracting the data according to a reverse sequential hierarchy by initiating the extraction of the data along the row associated with the terminal component.

9. The computer implemented method of claim 8, wherein extracting the data in a reverse sequential hierarchy includes: simultaneously processing the one or more threads by initiating the extraction of the data associated with the corresponding one or more terminal components.

10. The computer implemented method of claim 1 further comprising:
detecting a dataflow between a first succeeding workflow component and a second succeeding workflow component;
determining a processing request from the terminal component; and
sequentially extracting data along one or more rows corresponding to the first succeeding workflow component from the execution state table, to process the first succeeding workflow component.

11. The computer implemented method of claim 1 further comprising: optimizing the storing of the result descriptors in the execution state table by collating the result descriptors and updating the execution state table with the collated result descriptors.

12. The computer implemented method of claim 1 further comprising:
generating one or more separate workflow threads corresponding to one or more workflow chains with a common workflow component;
freezing the execution of succeeding workflow threads to process the workflow components of a first workflow thread; and
reusing the data from the execution state table to execute the common workflow components.

13. The computer implemented method of claim 1 further comprising:
upon executing the workflow, generating a unique access identifier for the result of the execution;
determining a status of each workflow component in the workflow and storing the unique access identifier and the status in the execution state table; and
accessing the execution state table to reuse the result of the execution of the workflow.

14. The computer implemented method of claim 1 further comprising: executing the workflow chain by executing one or more impacted data processes of the workflow chain.

15. The computer implemented method of claim 1, wherein the sequential hierarchy of the workflow components is capable of using an output of a preceding workflow component to execute a succeeding workflow component.

16. The computer implemented method of claim 1 further comprising:
identifying one or more workflow sub-chains;
performing parallel-processing of the workflow sub-chains.

17. The computer implemented method of claim 1, wherein the workflow includes:
the workflow components capable of representing one or more processing units of a predictive analysis system;
the workflow chains capable of establishing a link between the workflow components to define an order of the execution; and
a centralized repository capable of storing the execution state table.

18. A computer system to generate a workflow execution framework, comprising:
a processor configured to read and execute instructions stored in one or more memory elements; and
the one or more memory elements storing instructions related to—
an analysis engine—
to semantically analyze a received workflow and determine a workflow chain and associated one or more workflow components;
to detect a terminal component in the workflow chain and a corresponding sequential hierarchy of the workflow components, in response to a trigger to execute the workflow chain;
a execution engine—
to compute a result descriptor of a data source component corresponding to the terminal component and to generate an execution state table to store the result descriptor of the data source component;
to compute one or more result descriptors corresponding to the workflow components succeeding the data source component in the sequential hierarchy and to store the result descriptors corresponding to the succeeding workflow components in the execution state table;
a data extractor—
to detect a dataflow between the data source component and one of the succeeding workflow components; and
to extract data along each row of the execution state table and process the one of the succeeding workflow components.

19. An article of manufacture including a non-transitory computer readable storage medium to tangibly store instructions, which when executed by a computer, cause the computer to:
semantically analyze a received workflow to determine a workflow chain and associated one or more workflow components;
detect a terminal component in the workflow chain and a corresponding sequential hierarchy of the workflow components in response to a trigger to execute the workflow chain;
compute a result descriptor of a data source component corresponding to the terminal component and generate an execution state table to store the result descriptor of the data source component;
compute one or more result descriptors corresponding to the workflow components succeeding the data source component in the sequential hierarchy and store the result descriptors corresponding to the succeeding workflow components in the execution state table; and
extract data along each row of the execution state table and process the one of the succeeding workflow components, based upon detecting a dataflow between the data source component and one of the succeeding workflow components.

20. The article of manufacture of claim 19, further comprising:
in response to the trigger to execute the workflow chain, detecting one or more terminal components in the workflow chain and a corresponding one or more sequential hierarchies of the workflow components;
generating a workflow thread corresponding to each terminal component and associated workflow components in the workflow chain;
executing a first workflow thread by
computing a result descriptor of a data source component corresponding to the terminal component of the first workflow thread and storing the corresponding result descriptor in the execution state table;
computing the result descriptors corresponding to the workflow components succeeding the data source component in the sequential hierarchy of the first workflow thread and storing the result descriptors corresponding to the succeeding workflow components in the execution state table; and
upon detecting a dataflow between the data source component and one of the succeeding workflow components, extracting data along each row of the execution state table to process the one of the succeeding workflow components in the first workflow thread; and
upon processing the sequential hierarchy of the workflow components in the first thread, executing a second workflow thread.
